(19) United States
(12) Patent Application Publication
(10) Pub. No.: US 2003/0028619 A1
(43) Pub. Date: Feb. 6, 2003

(54) Linking user-defined panels to existing product panels

(75) Inventors: William Hsiao-Yu Ku, Austin, TX (US); John Shih-Yuan Wang, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/918,810

(22) Filed: Jul. 31, 2001

(51) Int. Cl. G09G 5/00; G06F 15/16

(52) U.S. Cl. 709/218; 345/760

(57) ABSTRACT

A method, apparatus, and computer implemented instructions for a panel for use in a graphical user interface in a data processing system. The panel includes a set of data objects for a panel and a set of navigation objects for the panel. The panel also includes a first list of data objects within the set of data objects, wherein the first list contains an identification of a data type for each data object within the first list. A second list of navigation objects is included in the panel in which the second list includes an event, a target object associated with the event, and a target object action associated with the target object in which the target object action is applied to the target object for each navigation object within the list.

### BACKGROUND OF THE INVENTION

1. Technical Field

The present invention relates generally to an improved data processing system and in particular to a method and apparatus for processing user input. Still more particularly, the present invention provides a method, apparatus, and computer implemented instructions for linking or associating panels or windows in a graphical user interface.

2. Description of Related Art

In data processing systems, graphical user interfaces (GUIs) are an important part of the input/output interface employed by users to interact with data processing systems. A GUI is used to present data to a user in various forms. The data may be presented using text, graphics, or even video. Additionally, GUIs often provide controls, such as buttons, sliders, or scroll bars, used to navigate within the data processing system.

Applications provided to users include GUIs, which provide access to the functionality of the applications. Some existing application products, however, do not necessarily provide functions needed by a user. Some applications allow for the adding of predefined functions to a GUI. For example, the user may add a function, such as save all open files, to a word processing program by selecting a tool bar function provided with the word processing program. This feature allows a user to add functions, but only those predefined in the application. In some cases, a user may desire to add a function that is not predefined by the application. Currently, such a feature is not readily available to users.

Therefore, it would be advantageous to have an improved method, apparatus, and computer implemented instructions for adding functionality to a graphical user interface.

### SUMMARY OF THE INVENTION

The present invention provides a method, apparatus, and computer implemented instructions for linking panels to an existing panel in a graphical user interface in a data processing system. The panel includes a set of data objects for a panel and a set of navigation objects for the panel. The panel also includes a first list of data objects within the set of data objects, wherein the first list contains an identification of a data type for each data object within the first list. A second list of navigation objects is included in the panel in which the second list includes an event, a target object associated with the event, and a target object action associated with the target object in which the target object action is applied to the target object for each navigation object within the list.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram of a set of panels in accordance with a preferred embodiment of the present invention;

FIG. 4 is a diagram of a panel system in accordance with a preferred embodiment of the present invention;

FIG. 5 is a diagram of a panel system in accordance with a preferred embodiment of the present invention;

FIG. 6 is a diagram illustrating a set of panels in accordance with a preferred embodiment of the present invention;

FIG. 7 is a table of name value pairs for identifying panels in accordance with a preferred embodiment of the present invention;

FIG. 8 is a diagram of pseudo code for a panel in accordance with a preferred embodiment of the present invention;

FIG. 9 is a flowchart of a process used for obtaining panel data in accordance with a preferred embodiment of the present invention; and

FIG. 10 is a diagram of pseudo code for obtaining panel data for a current panel in accordance with a preferred embodiment of the present invention.

### DETAILED DESCRIPTION OF THE PREFERRED EMBODIMENT

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

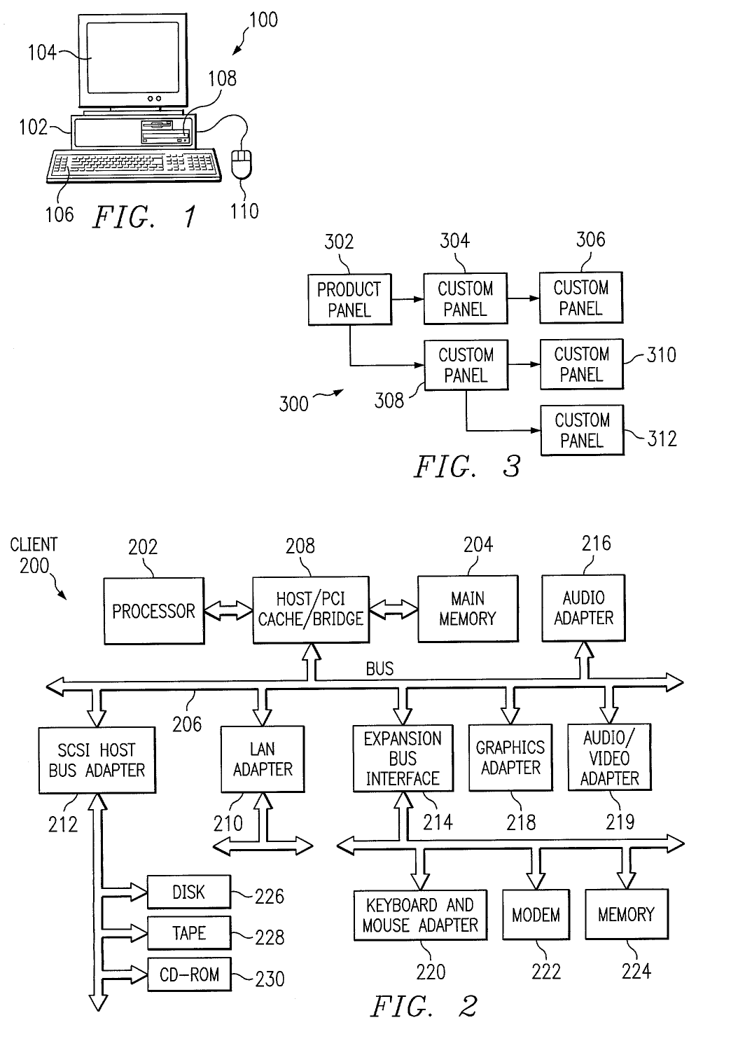

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide nonvolatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices 226-230.

The present invention provides an improved method, apparatus, and computer implemented instructions for linking panels in a graphical user interface (GUI). The mechanism of the present invention allows new panels to be linked to existing panels in which the existing panels do not need to be modified or know what processing occurs in the new panels.

Turning next to FIG. 3, a diagram of a set of panels is depicted in accordance with a preferred embodiment of the present invention. Panel system 300 includes product panel 302, custom panel 304, custom panel 306, custom panel 308, custom panel 310, and custom panel 312. In this example, product panel 302 does not care about the data located in custom panels 304-312. These custom panels are extensions of the product in panel system 300. Only the custom panels know what data the user has defined on those custom panels. To achieve this situation, a product panel may link to another product panel or a custom panel. A custom panel can only link to another custom panel not any product panel. In this example, product panel 302 is linked to custom panel 304 and custom panel 308. Custom panel 304 has a link to custom panel 306, while custom panel 308 is linked to custom panel 310 and custom panel 312. None of the links for custom panels lead to product panel 302.

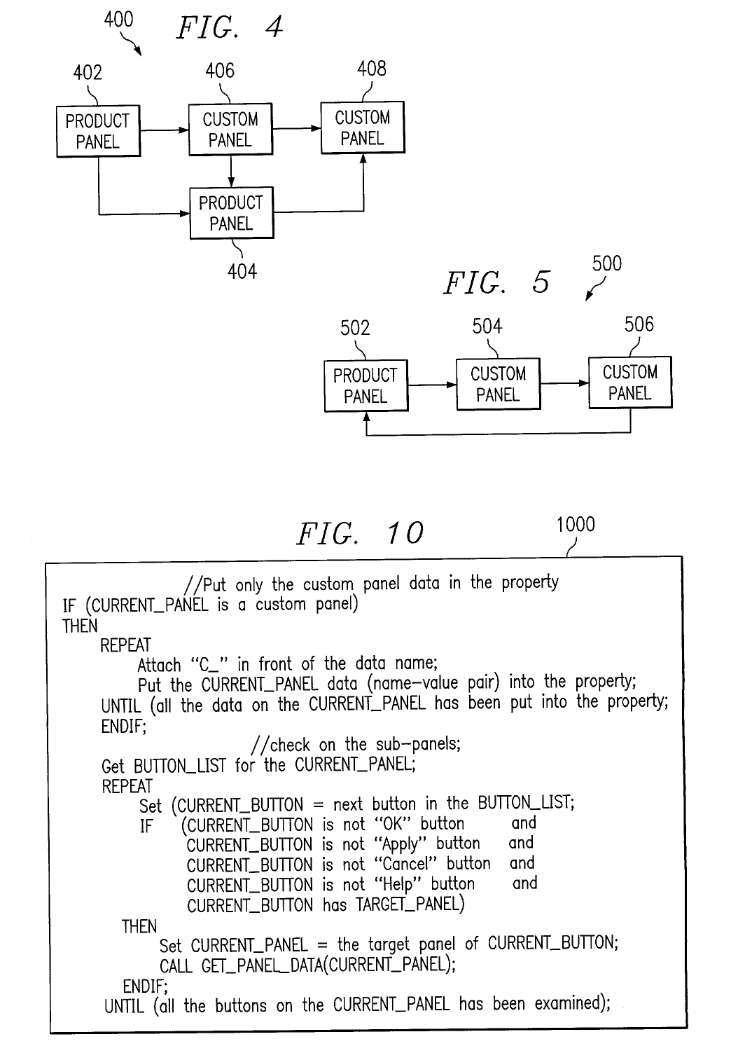

Turning next to FIG. 4, a diagram of a panel system is depicted in accordance with a preferred embodiment of the present invention. Panel system 400 includes product panel 402, product panel 404, custom panel 406, and custom panel 408. In this example, product panel 404 needs to know the data in custom panel 406. Product panel 402 is linked to custom panel 406 and product panel 404. Custom panel 406 has a link to custom panel 408 and product panel 404, and product panel 404 has a link to custom panel 408. In this case, a product panel can link to either another product panel or a custom panel. A custom panel can also link to either a product panel or a custom panel. The custom panels are truly integrated with the product.

With reference next to FIG. 5, a diagram of a panel system is depicted in accordance with a preferred embodiment of the present invention. Panel system 500 includes product panel 502, custom panel 504, and custom panel 506. Panel system 500 also requires that the product panels know what data is present in custom panels. Panel subsytem 500 is an example of circular linkage between panels.

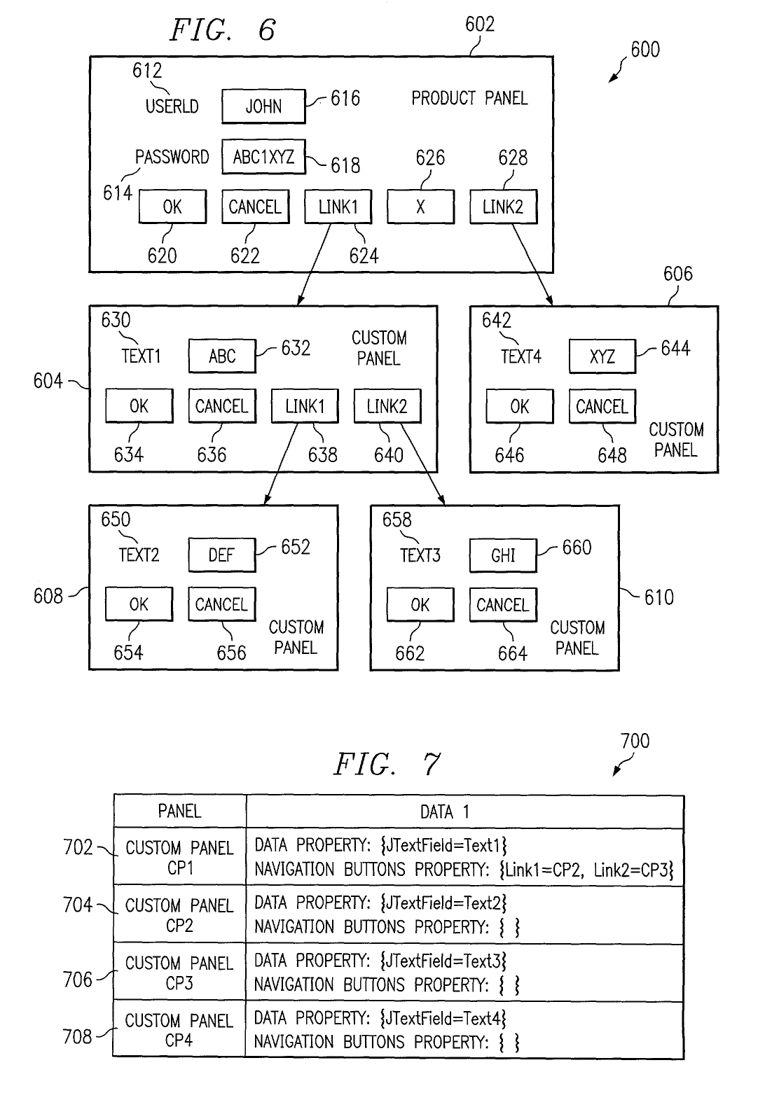

Turning next to FIG. 6, a diagram illustrating a set of panels is depicted in accordance with a preferred embodiment of the present invention. In this example, panel system 600 include product panel 602, custom panel 604, custom panel 606, custom panel 608, and custom panel 610. Product panel 602 includes information field 612 and information field 614 as well as text field 616 and text field 618. Additionally, product panel 602 includes “OK” button 620, “Cancel” button 622, “Link1” button 624, “X” button 626, and “Link2” button 628. “Link1” button 624 provides a link to custom panel 604, while “Link2” button 628 provides a link to custom panel 606.

Custom panel 604 includes information field 630 and text field 632. Custom panel 604 also includes “OK” button 634, “Cancel” button 636, “Link1” button 638, and “Link2” button 640. “Link1” button 638 provides a link to custom panel 608, while “Link2” button 640 provides a link to custom panel 610. Custom panel 606 includes information field 642 and text field 644 as well as “OK” button 646 and “Cancel” button 648.

Custom panel 608 includes information field 650, text 652, “OK” button 654, and “Cancel” button 656. In a similar fashion, custom panel 610 includes information field 658, text field 660, “OK” button 662, and “Cancel” button 664.

In these examples, buttons, such as an “OK” button, “Apply” button, “Cancel” button, and a “Help” button are non-navigation buttons. Other buttons associated with a target panel are link buttons, such as “Link1” button 624 in product panel 602 or “Link1” button 638 in custom panel 604.

Alternatively, a button may simply perform a task, which does not bring up an additional panel. For example, a button may only play a voice message to the user. This kind of button does not participate in any navigation and can be ignored here. “X” button 626 in product panel 602 falls into this category. This kind of button is called a “non-link” button.

In this example, a property is a set of name-value pairs that can be stored into the database table. An example is below:

{userId=John, password-abc1xyz}

where 2 name-value pairs exist in the property, the name “userId” with value “John” and name “password” with the value “abc1xyz”. “UserId” corresponds to information field 612, while “John” corresponds to data in text field 616 in product panel 602. Next, “password” corresponds to information field 614, while “abc1xyz” corresponds to the data in text field 618 in product panel 602.

In order to integrate product panel 602 and custom panels 604-610, product panel 602 needs to know about all the data on these custom panels. First, product panel 602 needs to know how many custom panels are linked into the product. Next, product panel 602 needs to know in what order the custom panels are linked. Product panel 602 also needs to know what data is contained on each of the custom panels.

In this example, product panel 602 has two link buttons, “Link1” button 624 and “Link2” button 628. Additionally, product panel 602 has one non-link button, “X” button 626. Custom panel 604 has two link buttons, “Link1” button 638 and “Link2” button 640. Custom panels 606, 608, and 610 are also called leaf panels, which have no link buttons.

With reference now to FIG. 7, a table of name value pairs for identifying panels is depicted in accordance with a preferred embodiment of the present invention. Table 700 includes the information needed for identifying information about custom panels for panel system 600 in FIG. 6. In this example, entry 702 is associated with custom panel 604, entry 704 is associated with custom panel 608, entry 706 is associated with custom panel 610, and entry 708 is associated with custom panel 606 in panel system 600. In each entry, a panel identification and a data field are present. Each data field contains a data property and a navigation buttons property.

In the example in table 700, the data property in each entry contains a set of name-value pairs in which the name is the data class type and the value is the object name.

The navigation buttons property contains a set of name-value pairs in which the name is the link button, and the value is the target panel. This information can be provided by a programmer who creates the custom panels. This information may be stored and retrieved from a file. Alternatively, if the panels are written using Java, this information also may be retrieved directly from the custom panel Java file.

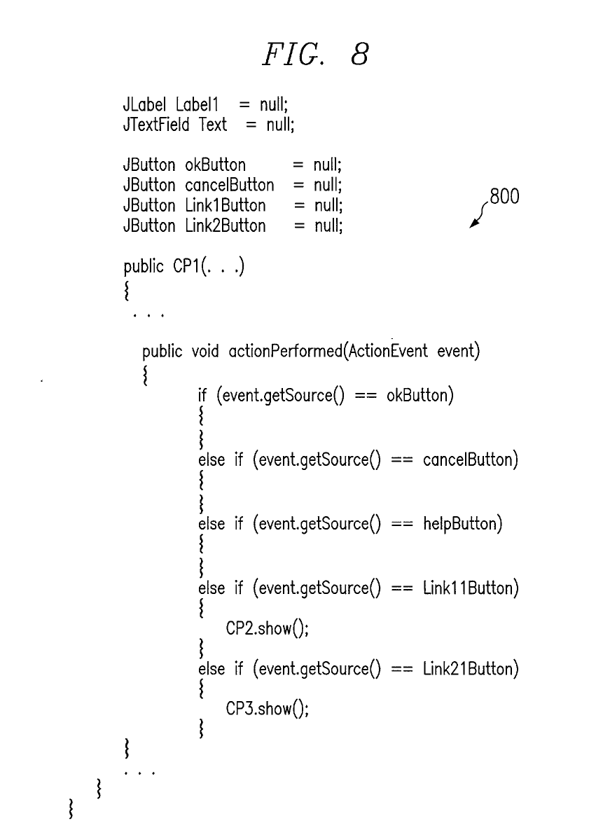

Turning next to FIG. 8, a diagram of pseudo code for a panel is depicted in accordance with a preferred embodiment of the present invention. Code 800 is an example of Java code, which may be used for a custom panel, such as custom panel 604 in FIG. 6.

By scanning through the CP1.java file, both:

data property: {JtextField=Text1}

navigation buttons property: {Link1=CP2, Link2=CP3}

can be obtained. This information is the information associated with entry 702 in FIG. 7. Next, the data of JtextField=Text1 can be obtained by applying:

Text1.getText( );

which returns the String “abc”.

On product panel 602 in FIG. 6, if “OK” button 620 is pressed, product panel 602 will be closed and all the data buttons on product panel 602 and also all the data on the linked custom panels, such as custom panel 604 and custom panel 606 in FIG. 6, will be stored into a database.

On product panel 602, if “Cancel” button 622 is pressed product panel 602 will be closed. All the changed data or settings on this product panel and all the linked custom panels will be discarded. The original data on those panels will be displayed next time when the panels are shown.

If the user enters “abc” in custom panel 604 in FIG. 6 and then selects “OK” button 634, custom panel 604 will be closed. If the user enters userId “John” into text field 616, enters the password “abc1xyz” in text field 618, and then presses “OK” button 620 on product panel 602, the property:

{UserId=John, Password=abc1xyz, Text1=abc}

will be stored into a database.

Since the user defined names on the custom panels, such as Text1 in information field 630 may be duplicated on another panel, such as product panel 602, confusion may occur in identifying different objects. As a result, in these examples, all of the names on the custom panels are assigned using a unique name. In order to accomplish this type of assignment, a special header “C_” is added to the custom defined name as:

{UserId=John, Password=abc1xyz, C_Text1=abc}

During display, the extra header “C_” is removed. When the name is stored, the extra header “C_” is added in front of the custom defined name.

In these examples, “product linking panel” is defined as a product panel that contains the custom link buttons.

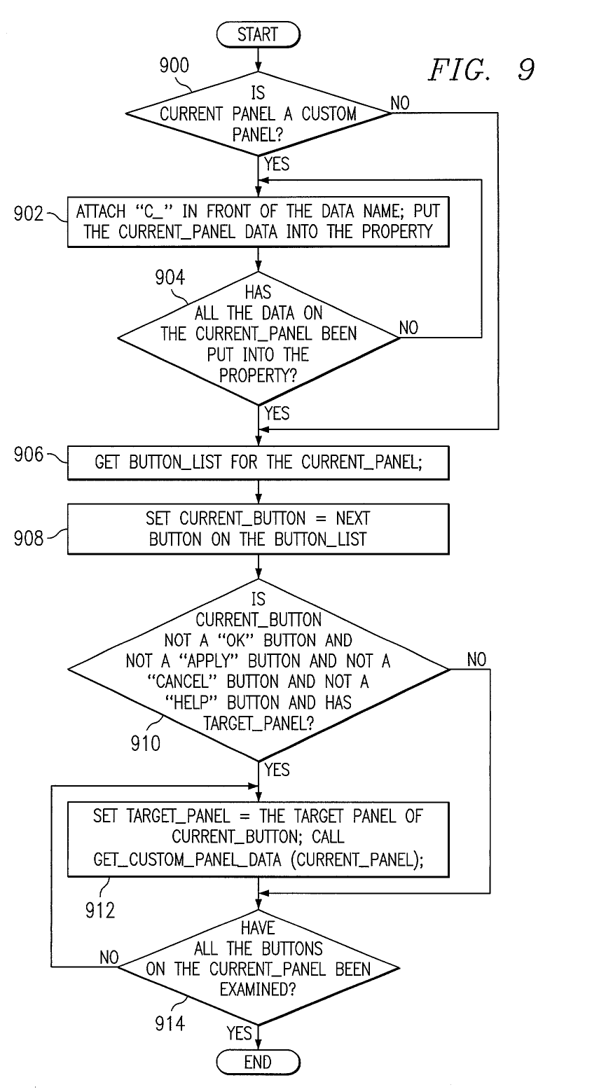

With reference now to FIG. 9, a flowchart of a process used for obtaining panel data is depicted in accordance with a preferred embodiment of the present invention. The process illustrated in FIG. 9 may be implemented in a data processing system, such as data processing system 200 in FIG. 2. This process may be implemented as a recursive process.

The process begins with a determination as to whether a current panel is a custom panel (step 900). If the current panel is a custom panel, “C_” is attached in front of the data name, and the CURRENT_PANEL data is put into the property (step 902). In step 902, the data is data associated with a panel from user input. For example, custom panel 904 in FIG. 9 has only one set of data. As a result, the process would not return to step 902. If another data field were present, then the process would return to step 902. The “C_” is used to differentiate the data name in a custom panel to avoid possibly using the same data name as in a product panel. In these examples, CURRENT_PANEL is the product linking panel. This property is similar to the data property and navigations button property illustrated in FIG. 10.

Next, a determination is made as to whether all of the data on the CURRENT_PANEL has been put into the property (step 904). If the answer to this determination is yes, a BUTTON_LIST is retrieved for the CURRENT_PANEL (step 906). The CURRENT_BUTTON is set equal to the next button on the BUTTON_LIST (step 908). BUTTON_LIST may be defined by a programmer or may be obtained from parsing the existing Java code for the panel, such as in FIG. 8.

A determination is then made as to whether the CURRENT_BUTTON is not an “OK” button, not an “Apply” button, not a “Cancel” button, not a “Help” button, and has a TARGET_PANEL (step 910). If the CURRENT_BUTTON is not an “OK” button, not an “Apply” button, not a “Cancel” button, not an “Help” button and has a TARGET_PANEL, the TARGET_PANEL is set equal to the target panel of the CURRENT_BUTTON and a call GET_CUSTOM_PANEL_DATA (CURRENT_PANEL) is made (step 912). Next, a determination is made as to whether all of the buttons on the CURRENT_PANEL have been examined (step 914). If all of the buttons on the CURRENT_PANEL have been examined, the process terminates. Otherwise, the process returns to step 912 as described above.

Turning back to step 910, if the CURRENT_BUTTON is an “OK” button, or “Apply” button, or “Cancel” button, or “Help” button, or does not have a TARGET_PANEL, the process proceeds to step 914 as described above. With reference again to step 904, if all of the data on the CURRENT_PANEL has not been put into the property, the process returns to step 902. Turning again to step 900, if the current panel is not a custom panel, the process proceeds to step 906 as described above.

In applying the process in FIG. 9 to the example depicted in FIG. 6, if product panel 602 has no custom panels attached to it and “OK” button 620 is pressed, the following property is stored into a database:

{UserId=John, Password=abc1xyz}

In this example, since custom panel 604 is attached to product panel 602 through “Link1” button 624, the following property is added as:

{UserId=John, Password=abc1xyz, C_Text1=abc}

In this example, since custom panel 608 is attached to custom panel 604 through “Link1” button 638, the following property is added as:

{UserId=John, Password=abc1xyz, C_Text1=abc, C_Text2=def}

Custom panel 610 is attached to custom panel 604 through “Link2” button 640, the following property is added as:

{UserId=John, Password=abc1xyz, C_Text1=abc, C_Text2=def, C_Text3=ghi}

As shown in FIG. 6, custom panel 606 is attached to product panel 602 through “Link2” button 628, the following property is added as:

{UserId=John, Password=abc1xyz, C_Text1=abc, C_Text2=def, C_Text3=ghi, C_Text4=xyz}.

Turning next to FIG. 10, a diagram of pseudo code is provided for obtaining panel data for a current panel in accordance with a preferred embodiment of the present invention. In this example, pseudo code 1000 may be implemented in a data processing system, such as data processing system 200 in FIG. 2. This pseudo code is an example of code that may be created to implement the process illustrated in FIG. 9.

Thus, the present invention provides an improved method, apparatus, and computer implemented instructions for adding panels to a graphical user interface. The mechanism of the present invention allows for an integration of new panels within existing panels. The existing panels do not need to know of the processing occurring within the new panels with this mechanism.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for linking panels in a graphical user interface, the method comprising:
creating a set of data objects for a panel, wherein each data object within the set of data objects is associated with a data type; and
creating a set of navigation objects for the panel, wherein each navigation object within the set of navigation objects is associated with an event, a target object associated with the event, and a target object action associated with the target object in which the target object action is applied to the target object.

2. The method of claim 1, wherein the set of data objects includes at least one of a text field, a combo box, and a radio button.

3. The method of claim 1, wherein the set of navigation objects includes at least one of a button, a slider, and a scroll bar.

4. The method of claim 1, wherein the event is a right mouse click.

5. The method of claim 1, wherein the event is a depression of a function key.

6. The method of claim 1, wherein an identification of the set of data objects and associations are stored in a list.

7. The method of claim 1, wherein an identification of the set of navigation objects and associations are stored in a list.

8. The method of claim 1 further comprising:
creating a set of information objects for the panel.

9. A panel for use in a graphical user interface, the panel comprising:
a set of data objects for a panel;
a set of navigation objects for the panel;
a first list of data objects within the set of data objects, wherein the first list contains an identification of a data type for each data object within the first list; and
a second list of navigation objects within the set of navigation objects, wherein the second list includes an event, a target object associated with the event, and a target object action associated with the target object in which the target object action is applied to the target object for each navigation object within the list.

10. The panel of claim 9 further comprising:
a set of information objects.

11. A data processing system comprising:
a bus system;
a communications unit connected to the bus system;
a memory connected to the bus system, wherein the memory includes a set of instructions; and
a processing unit connected to the bus system, wherein the processing unit executes the set of instructions to create a set of data objects for a panel, wherein each data object within the set of data objects is associated with a data type; and create a set of navigation objects for the panel, wherein each navigation object within the set of navigation objects is associated with an event, a target object associated with the event, and a target object action associated with the target object in which the target object action is applied to the target object.

12. A data processing system for linking panels in a graphical user interface, the data processing system comprising:
first creating means for creating a set of data objects for a panel, wherein each data object within the set of data objects is associated with a data type; and
second creating means for creating a set of navigation objects for the panel, wherein each navigation object within the set of navigation objects is associated with an event, a target object associated with the event, and a target object action associated with the target object in which the target object action is applied to the target object.

13. The data processing system of claim 12, wherein the set of data objects includes at least one of a text field, a combo box, and a radio button.

14. The data processing system of claim 12, wherein the set of navigation objects includes at least one of a button, a slider, and a scroll bar.

15. The data processing system of claim 12, wherein the event is a right mouse click.

16. The data processing system of claim 12, wherein the event is a depression of a function key.

17. The data processing system of claim 12, wherein an identification of the set of data objects and associations are stored in a list.

18. The data processing system of claim 12, wherein an identification of the set of navigation objects and associations are stored in a list.

19. The data processing system of claim 12 further comprising:
third creating means for creating a set of information objects for the panel.

20. A computer program product in a computer readable medium for linking panels in a graphical user interface, the computer program product comprising:
first instructions for creating a set of data objects for a panel, wherein each data object within the set of data objects is associated with a data type; and
second instructions for creating a set of navigation objects for the panel, wherein each navigation object within the set of navigation objects is associated with an event, a target object associated with the event, and a target object action associated with the target object in which the target object action is applied to the target object.

21. The computer program product of claim 20, wherein the set of data objects includes at least one of a textfield, a combo box, and a radio button.

22. The computer program product of claim 20, wherein the set of navigation objects includes at least one of a button, a slider, and a scroll bar.

23. The computer program product of claim 20, wherein the event is a right mouse click.

24. The computer program product of claim 20, wherein the event is a depression of a function key.

25. The computer program product of claim 20, wherein an identification of the set of data objects and associations are stored in a list.

26. The computer program product of claim 20, wherein an identification of the set of navigation objects and associations are stored in a list.

27. The computer program product of claim 20 further comprising:
third instructions for creating a set of information objects for the panel.
